(19) United States
(12) Patent Application Publication
(10) Pub. No.: US 2018/0222721 A1
(43) Pub. Date: Aug. 9, 2018

(54) ELEVATOR TENSION MEMBER

(71) Applicant: Otis Elevator Company, Farmington, CT (US)

(72) Inventors: John P. Wesson, West Hartford, CT (US); Huan Zhang, Glastonbury, CT (US); Scott Alan Eastman, Glastonbury, CT (US); Gopal R. Krishnan, Wethersfield, CT (US)

(21) Appl. No.: 15/425,013

(22) Filed: Feb. 6, 2017

(51) Int. Cl. B66B 7/06; D07B 1/22; D07B 7/14

(52) U.S. Cl. CPC B66B 7/062; B66B 9/00; D07B 7/145; D07B 1/22

(57) ABSTRACT

A belt for suspending and/or driving an elevator car includes a plurality of cords. Each cord includes a plurality of wires and at least one yarn thread disposed at an outer periphery of the plurality of wires. An elastomeric jacket substantially retains the plurality of cords. The at least one yarn thread is configured to promote adhesion of the elastomeric jacket to the plurality of cords and reduce fretting of the plurality of wires. A method of forming a belt includes arranging a plurality of wires into a cord, arranging one or more yarn threads at an outer periphery of the plurality of wires, arranging a plurality of cords into a selected arrangement and applying an elastomeric jacket to the cords to retain the cords. The one or more yarn threads are configured to promote adhesion of the elastomeric jacket to the cords and reduce fretting of the wires.

### CROSS-REFERENCE TO RELATED APPLICATIONS

This application claims the benefit of Provisional Application No. 62/293,044 filed Feb. 9, 2016, which is incorporated herein by reference in its entirety.

### BACKGROUND

The subject matter disclosed herein relates to tension members such as those used in coated belts of elevator systems for suspension and/or driving of the elevator car and/or counterweight.

Tension members for elevators typically include a one or more cords formed from a plurality of steel wires arranged in a geometrically stable configuration. Depending on wire diameters, only a certain number of geometrically stable arrangements are possible. Cords are often arranged into a belt which comprises a plurality of such cords at least partially enclosed in an elastomeric jacket material.

Adhesion and load transfer between the steel tension members in a coated belt provides a critical load path. In addition, bonding stabilizes the construction of multi-wire, multi-strand steel cord. This helps minimize fretting, wear and wire breakage. In cases where wire breakage occurs, the bonding with the elastomer jacket will hold the broken wire in place, reducing further damage to the strand, cord and belt.

Good penetration of the elastomeric jacket material into the steel cord structure and bonding between the elastomeric jacket and the typically zinc plated steel cords is limited. The use of cords pre-treated with a chemical bonding agent and the use of adhesives between the elastomeric jacket material and the steel cords are known approaches to increase adhesion between the cords and the jacket material. Each can be done with an increase in cord cost. Other approaches are sought that could improve the interface between steel cord and elastomer jacket.

### SUMMARY

In one embodiment, a belt for suspending and/or driving an elevator car includes a plurality of cords. Each cord includes a plurality of wires and at least one yarn thread disposed at an outer periphery of the plurality of wires. An elastomeric jacket substantially retains the plurality of cords. The at least one yarn thread is configured to promote adhesion of the elastomeric jacket to the plurality of cords and reduce fretting of the plurality of wires.

Additionally or alternatively, in this or other embodiments the at least on yarn thread is helically wrapped around the plurality of wires.

Additionally or alternatively, in this or other embodiments the at least one yarn thread is at least two yarn threads wrapped helically around the plurality of wires, the at least two yarn threads having equal lay lengths around the plurality of wires.

Additionally or alternatively, in this or other embodiments the at least one yarn thread is at least two yarn threads wrapped helically around the plurality of wires, the at least two yarn threads having opposite lay directions around the plurality of wires.

Additionally or alternatively, in this or other embodiments the at least one yarn thread comprises a fabric sleeve disposed at an outer periphery of the plurality of wires.

Additionally or alternatively, in this or other embodiments the fabric sleeve comprises at least two yarn threads woven or braided into the fabric sleeve.

Additionally or alternatively, in this or other embodiments the at least one yarn thread is formed from a polyester, nylon polyurethane, cotton, wool, rayon, fluoropolymer, or Kevlar material.

Additionally or alternatively, in this or other embodiments the plurality of wires are arranged into a plurality of strands, the plurality of strands arranged into the cord, at least one strand of the plurality of strands including at least one yarn thread disposed at an outer periphery of the at least one strand.

In another embodiment, a method of forming a belt for suspending and/or driving an elevator car includes arranging a plurality of wires into a cord, arranging one or more yarn threads at an outer periphery of the plurality of wires, arranging a plurality of cords into a selected arrangement and applying an elastomeric jacket to the plurality of cords to retain the plurality of cords in the selected arrangement. The one or more yarn threads are configured to promote adhesion of the elastomeric jacket to the plurality of cords and reduce fretting of the plurality of wires

Additionally or alternatively, in this or other embodiments the one or more yarn threads are arranged at the outer periphery of the plurality of wires prior to a cord closing operation performed on the plurality of wires to arrange the plurality of wires into a cord.

Additionally or alternatively, in this or other embodiments the one or more yarn threads are helically wound around the plurality of wires.

Additionally or alternatively, in this or other embodiments two or more yarn threads are helically wound around the plurality of wires, the two or more yarn threads having equal lay lengths.

Additionally or alternatively, in this or other embodiments two or more yarn threads are helically wound around the plurality of wires, the two or more yarn threads having opposite lay directions.

Additionally or alternatively, in this or other embodiments the one or more yarn threads are formed into a fabric sleeve around the plurality of wires.

Additionally or alternatively, in this or other embodiments the fabric sleeve is formed via one of a weaving or braiding process.

Additionally or alternatively, in this or other embodiments the one or more yarn threads are partially melted prior to applying the elastomeric jacket to promote adhesion of the one or more yarn threads to the plurality of wires.

Additionally or alternatively, in this or other embodiments the plurality of wires are arranged into a strand, one or more yarn threads are located at an outer periphery of the plurality of wires and a plurality of strands are formed into the cord.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic of an exemplary elevator system having a 1:1 roping arrangement;

FIG. 1B is a schematic of another exemplary elevator system having a different roping arrangement;

FIG. 1C is a schematic of another exemplary elevator system having a cantilevered arrangement;

FIG. 2 is a cross-sectional view of an embodiment of an elevator belt;

FIG. 3 is a cross-sectional view of an embodiment of a cord for an elevator belt;

FIG. 4 is a cross-sectional view of an embodiment of a cord including a plurality of yarn threads disposed thereat;

FIG. 5 is a schematic view of a manufacturing process for an embodiment of an elevator belt;

FIG. 6 is a perspective view of another embodiment of a cord for an elevator belt;

FIG. 7 is a perspective view of yet another embodiment of a cord for an elevator belt;

FIG. 8 is a perspective view of still another embodiment of a cord for an elevator belt; and

FIG. 9 is a cross-sectional view of an embodiment of a cord for an elevator belt including a fabric sleeve.

### DETAILED DESCRIPTION

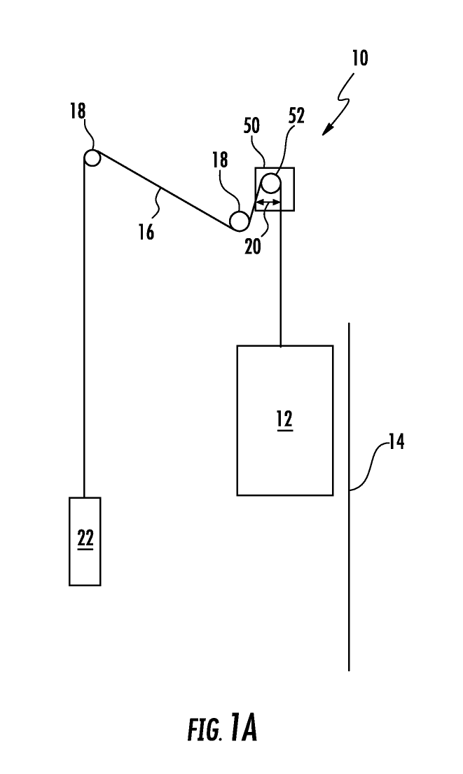

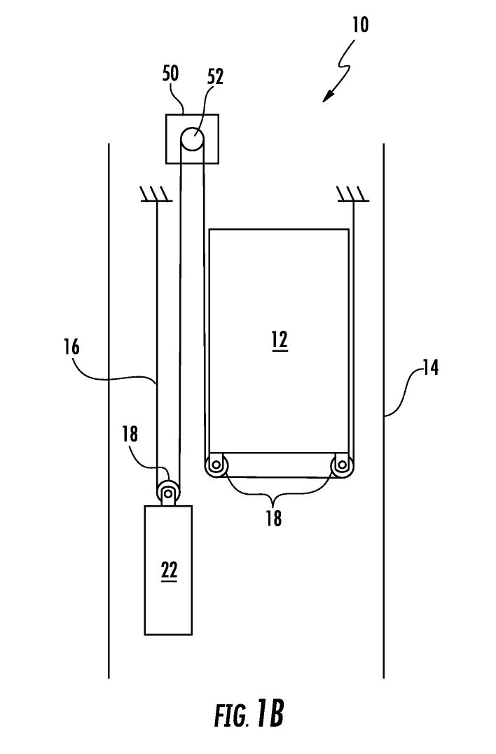

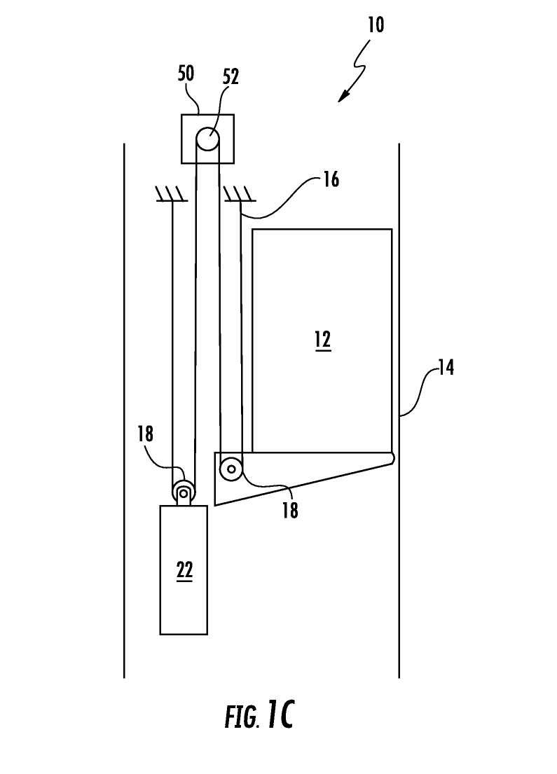

Shown in FIGS. 1A, 1B and 1C are schematics of exemplary traction elevator systems 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more belts 16. The one or more belts 16 interact with one or more sheaves 18 to be routed around various components of the elevator system 10. The one or more belts 16 could also be connected to a counterweight 22, which is used to help balance the elevator system 10 and reduce the difference in belt tension on both sides of the traction sheave during operation.

The sheaves 18 each have a diameter 20, which may be the same or different than the diameters of the other sheaves 18 in the elevator system 10. At least one of the sheaves 18 could be a drive sheave. The drive sheave 52 is driven by a machine 26. Movement of the drive sheave 52 by the machine 26 drives, moves and/or propels (through traction) the one or more belts 16 that are routed around the drive sheave 52.

At least one of the sheaves 18 could be a diverter, deflector or idler sheave. Diverter, deflector or idler sheaves are not driven by a machine 50, but help guide the one or more belts 16 around the various components of the elevator system 10.

In some embodiments, the elevator system 10 could use two or more belts 16 for suspending and/or driving the elevator car 12. In addition, the elevator system 10 could have various configurations such that either both sides of the one or more belts 16 engage the one or more sheaves 18 (such as shown in the exemplary elevator systems in FIG. 1A, 1B or 1C) or only one side of the one or more belts 16 engages the one or more sheaves 18.

FIG. 1A provides a 1:1 roping arrangement in which the one or more belts 16 terminate at the car 12 and counterweight 22. FIGS. 1B and 1C provide different roping arrangements. Specifically, FIGS. 1B and 1C show that the car 12 and/or the counterweight 22 can have one or more sheaves 18 thereon engaging the one or more belts 16 and the one or more belts 16 can terminate elsewhere, typically at a structure within the hoistway 14 (such as for a machineroomless elevator system) or within the machine room (for elevator systems utilizing a machine room. The number of sheaves 18 used in the arrangement determines the specific roping ratio (e.g. the 2:1 roping ratio shown in FIGS. 1B and 1C or a different ratio). FIG. 1C also provides a so-called rucksack or cantilevered type elevator. The present invention could be used on elevator systems other than the exemplary types shown in FIGS. 1A, 1B and 1C.

FIG. 2 provides a schematic of an exemplary belt construction or design. Each belt 16 is constructed of one or more cords 24 in a jacket 26. The cords 24 of the belt 16 could all be identical, or some or all of the cords 24 used in the belt 16 could be different than the other cords 24. For example, one or more of the cords 24 could have a different construction or size than the other cords 24. As seen in FIG. 2, the belt 16 has an aspect ratio greater than one (i.e. belt width is greater than belt thickness).

The belts 16 are constructed to have sufficient flexibility when passing over the one or more sheaves 18 to provide low bending stresses, meet belt life requirements and have smooth operation, while being sufficiently strong to be capable of meeting strength requirements for suspending and/or driving the elevator car 12.

The jacket 26 could be any suitable material, including a single material, multiple materials, two or more layers using the same or dissimilar materials, and/or a film. In one arrangement, the jacket 26 could be a polymer, such as an elastomer, applied to the cords 24 using, for example, an extrusion or a mold wheel process. In another arrangement, the jacket 26 could be a woven fabric that engages and/or integrates the cords 24. As an additional arrangement, the jacket 26 could be one or more of the previously mentioned alternatives in combination.

The jacket 26 can substantially retain the cords 24 therein. The phrase substantially retain means that the jacket 26 has sufficient engagement with the cords 24 such that the cords 24 do not pull out of, detach from, and/or cut through the jacket 26 during the application on the belt 16 of a load that can be encountered during use in an elevator system 10 with, potentially, an additional factor of safety. In other words, the cords 24 remain at their original positions relative to the jacket 26 during use in an elevator system 10. The jacket 26 could completely envelop the cords 24 (such as shown in FIG. 2), substantially envelop the cords 24, or at least partially envelop the cords 24.

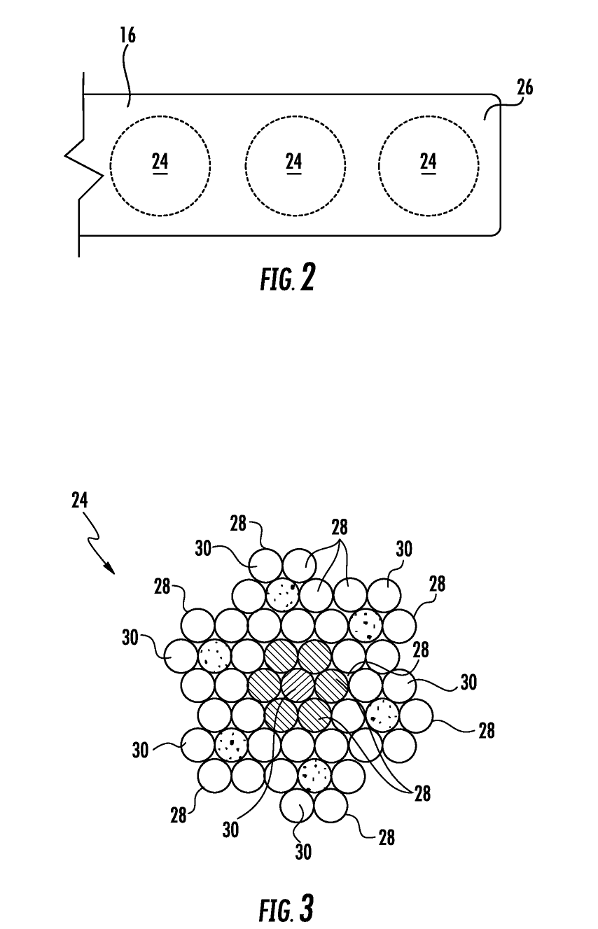

Referring now to FIG. 3, each cord 24 comprises a plurality of wires 28 in a geometrically stable arrangement. The wires 28 are formed from steel or other load-carrying material. The steel wires 28 provide the tensile strength of the cord 24 and determine the bending stress of the cord 24 which, in turn, determines the cord 24 life. Optionally, some or all of these wires 28 could be formed into strands 30, which are then formed into the cord 24. The phrase geometrically stable arrangement means that the wires 28 (and if used, strands 30) generally remain at their theoretical positions in the cord 24. In other words, movement of the wires 28 (and if used, strands 30) relative to each other is limited. For example, relative movement of wire 28 could be limited to less than approximately thirty percent (30%) of its diameter. Relative movement of strand 30 could be limited to less than approximately five percent (5%) of its diameter.

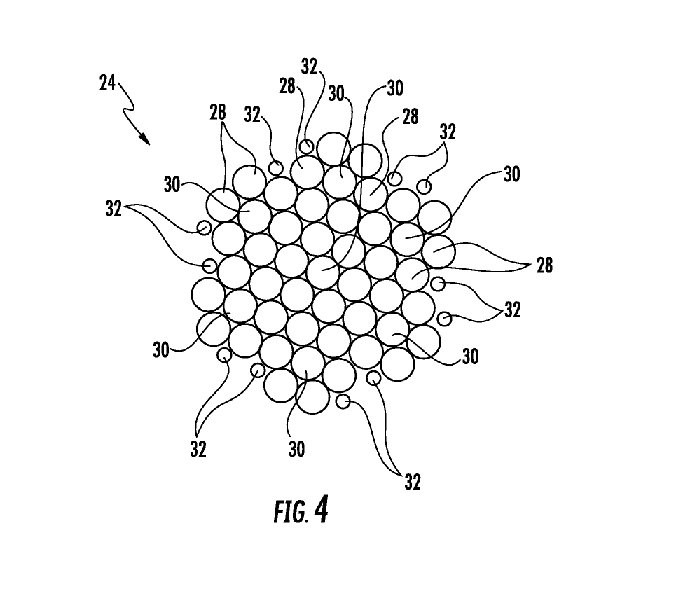

Referring now to FIG. 4, the cord 24 includes improvements to increase adhesion of the elastomeric jacket 26 material to the cord 24, and to reduce fretting of the cord 24, thus improving a service life of the cord 24 and thus the belt 16 in which the cord 24 is installed. In the embodiment of FIG. 4, a plurality of fabric yarn threads 32 or elements are incorporated into the cord 24. The yarn threads 32 are organic materials that bond more easily to the thermoplastic elastomer of the jacket 26 than do the steel materials of the cord 24. The yarn threads 32 may be formed from, for example, polyester, nylon, polyurethane, cotton, wool, rayon, fluoropolymer, Kevlar or other materials. In some embodiments, the yarn threads 32 may be treated with, for example, an adhesive, thermoplastic, or hot melt adhesive material to improve adhesion of the yarn threads 32 to the steel cord 24 and/or to improve adhesion of the jacket 26 material to the yarn threads 32. Further, the yarn threads 32 may include other additives, such as those to inhibit corrosion of the steel cord 24.

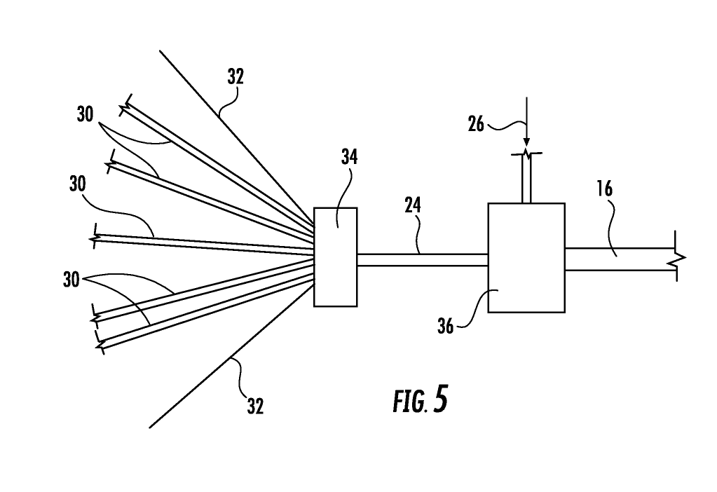

In some embodiments, such as that of FIG. 4, the yarn threads 32 are incorporated into the cord 24 at a cord closing operation of cord 24 manufacture. Referring to the schematic of FIG. 5, during the cord 24 closing operation, the individual strands 30 of the cord 24 are brought together by, for example, twisting and/or other operations to form a unitary cord 24. As such, the yarn threads 32 may be fed into a cord closing apparatus 34 along with the strands 30 and “closed” into the cord 24 during this operation. Referring again to FIG. 4, while the yarn threads 32 are shown at an outer periphery of the cord 24, it is to be appreciated that in other embodiments, the yarn threads 32 may alternatively or additionally be located at an interior of the cord 24, for example, between adjacent strands 30 and/or between adjacent wires 28 of the same strand 30.

Referring again to FIG. 5, after the cord 24 closing operation, the cords 24 of the belt 16 are arranged into desired positions, and the jacket 26 material is applied by, for example an extrusion process at jacket extruder 36. In some embodiments, the yarn threads 32 may be heated to a partially melted condition either prior to reaching the jacket extruder 36 or at the jacket extruder 36. The partial melting of the yarn threads 32 increases adhesion of the yarn threads 32 to the cord 24 and allows the yarn thread 32 material to penetrate between wires 28 of the cord 24.

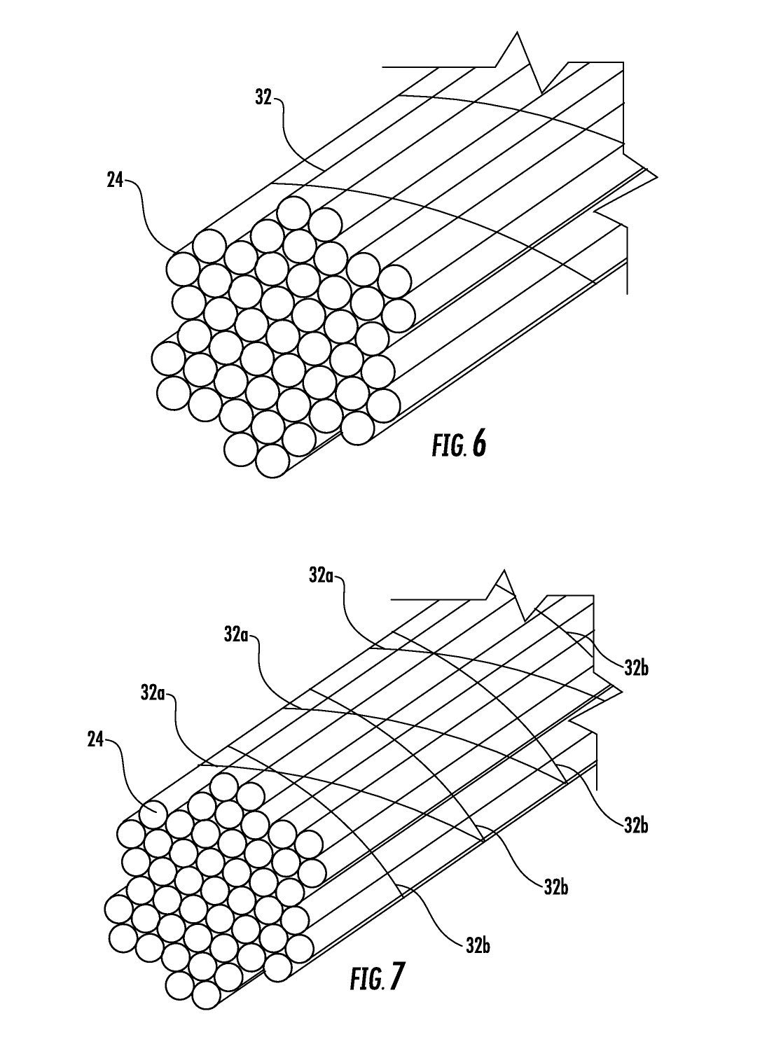

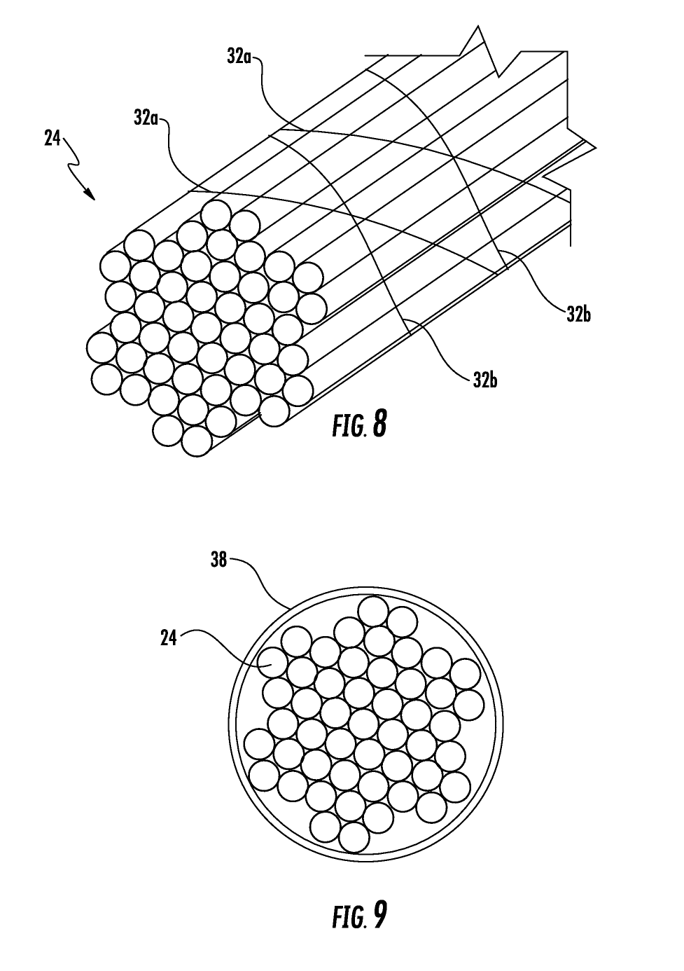

In another embodiment, as illustrated in FIG. 6, after the cord 24 closing operation is performed, one or more yarn threads 32 are wrapped around the cord 24 in a helical arrangement. The yarn threads 32 are spaced along a length of the cord 24 to allow for a selected amount of jacket 26 material penetration when the jacket material 26 is applied to the cord 24. In some embodiments, yarn threads 32 may be wrapped in parallel around the cord 24 and have equal lay lengths, while in other embodiments, such as shown in FIG. 7, yarn threads 32a and 32b may have unequal lay lengths resulting in the crossing of yarn threads 32a and 32b along the length of the cord 24. Further, in other embodiments, such as shown in FIG. 8, yarn threads 32a and 32b may be wrapped around cord 24 in opposite lay directions. While in the embodiments shown in FIGS. 6-8 the yarn threads 32 are helically wrapped around cords 32 after the cord 24 closing operation, it is to be appreciated that, in other embodiments, one or more strands 30 of the cord 24 may be helically wrapped with yarn threads 32, then the strands 30 are formed into cord 24.

In another embodiment, schematically shown in FIG. 9, a braiding or weaving process is utilized to sheath the cord 24 in a fabric sleeve 38 formed from a plurality of yarn threads 32. The fabric sleeve 38 may be co-formed with the belt 16 after the cord 24 closing process and before application of the jacket 26 material. The fabric sleeve 38 is tensioned during formation and placement around the cord 24 to fit tightly to the cord 24. Additionally, the yarn threads 32 could be heat treated to either adhere to the cord 24 or shrink around the cord 24 in a manner akin to heat shrinking. Further, the fabric sleeve 38 is formed with sufficient porosity to allow for a selected amount of penetration of the jacket material 36 between the yarn threads 32. While in the embodiment of FIG. 9, the fabric sleeve 38 is formed around the cord 24, it is to be appreciated that, in other embodiments, the fabric sleeve 38 may be applied to one or more strands 30 of the cord 24 before the strands 30 are formed into the cord 24.

Belts 16 with cords 24 including yarn thread 32 interfaces between the steel cords 24 and the elastomeric jacket 26 promotes adhesion of the cords 24 to the elastomeric jacket 26 improving a cord 24 to jacket 26 load path, and reduces fretting of the cords 24 to extend a service life of the cords 14 and thus the belt 16.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A belt for suspending and/or driving an elevator car, comprising:
a plurality of cords, each cord including:
a plurality of wires; and
at least one yarn thread disposed at an outer periphery of the plurality of wires; and
an elastomeric jacket substantially retaining the plurality of cords;
wherein the at least one yarn thread is configured to promote adhesion of the elastomeric jacket to the plurality of cords and reduce fretting of the plurality of wires.

2. The belt of claim 1, wherein the at least on yarn thread is helically wrapped around the plurality of wires.

3. The belt of claim 1, wherein the at least one yarn thread is at least two yarn threads wrapped helically around the plurality of wires, the at least two yarn threads having equal lay lengths around the plurality of wires.

4. The belt of claim 1, wherein the at least one yarn thread is at least two yarn threads wrapped helically around the plurality of wires, the at least two yarn threads having opposite lay directions around the plurality of wires.

5. The belt of claim 1, wherein the at least one yarn thread comprises a fabric sleeve disposed at an outer periphery of the plurality of wires.

6. The belt of claim 5, wherein the fabric sleeve comprises at least two yarn threads woven or braided into the fabric sleeve.

7. The belt of claim 1, wherein the at least one yarn thread is formed from a polyester, nylon polyurethane, cotton, wool, rayon, fluoropolymer, or Kevlar material.

8. The belt of claim 1, wherein the plurality of wires are arranged into a plurality of strands, the plurality of strands arranged into the cord, at least one strand of the plurality of strands including at least one yarn thread disposed at an outer periphery of the at least one strand.

9. A method of forming a belt for suspending and/or driving an elevator car, comprising:
arranging a plurality of wires into a cord;
arranging one or more yarn threads at an outer periphery of the plurality of wires;
arranging a plurality of cords into a selected arrangement;
applying an elastomeric jacket to the plurality of cords to retain the plurality of cords in the selected arrangement;
wherein the one or more yarn threads are configured to promote adhesion of the elastomeric jacket to the plurality of cords and reduce fretting of the plurality of wires.

10. The method of claim 9, wherein the one or more yarn threads are arranged at the outer periphery of the plurality of wires prior to a cord closing operation performed on the plurality of wires to arrange the plurality of wires into a cord.

11. The method of claim 9, wherein the one or more yarn threads are helically wound around the plurality of wires.

12. The method of claim 11, wherein two or more yarn threads are helically wound around the plurality of wires, the two or more yarn threads having equal lay lengths.

13. The method of claim 11, wherein two or more yarn threads are helically wound around the plurality of wires, the two or more yarn threads having opposite lay directions.

14. The method of claim 9, further comprising forming the one or more yarn threads into a fabric sleeve around the plurality of wires.

15. The method of claim 14, further comprising forming the fabric sleeve via one of a weaving or braiding process.

16. The method of claim 9, further comprising partially melting the one or more yarn threads prior to applying the elastomeric jacket to promote adhesion of the one or more yarn threads to the plurality of wires.

17. The method of claim 9, further comprising:
arranging the plurality of wires into a strand;
arranging one or more yarn threads at an outer periphery of the plurality of wires; and
forming a plurality of strands into the cord.
